(19) United States
(12) Patent Application Publication
(10) Pub. No.: US 2005/0118558 A1
(43) Pub. Date: Jun. 2, 2005

(54) System and method for improving learning and retention by using neurolinguistic programming layout

(76) Inventors: Steven E. Wallis, Petaluma, CA (US); Chance Massaro, Santa Rosa, CA (US)

Correspondence Address: Steven E. Wallis, 1656 Wynoochee Way, Petaluma, CA, 94954, US

(21) Appl. No.: 10/726,113

(22) Filed: Dec. 2, 2003

(51) Int. Cl. G09B 19/00

(52) U.S. Cl. 434/236

(57) ABSTRACT

System and method for improving the way that visual information is learned by the viewer through the presentation of said information according to type of content and its location relative to the reader's field of vision. The present invention relates to a method and system for improving comprehension and memory of information that is presented visually. In particular, the present invention refers to such information that has been distilled into “chunks” that are most relevant to the part of the brain that is stimulated by the eyes being forced in that direction. Finally, this invention relates to techniques for stimulating the reader's brain by way of moving the eyes.

### REFERENCES CITED

U.S. Patent Documents:

U.S. Pat. No. 4,456,347
Date: June 1984
Inventor: Stahly
Class: 351/158
U.S. Pat. No. 4,728,293
Date: March 1988
Inventor: Kole
Class: 434/236
U.S. Pat. No. 5,352,181
Date: October 1994
Inventor: Mark
Class: 600/28
U.S. Pat. No. 5,516,290
Date: April 1996
Inventor: Quigley, et al
Class: 434/129
U.S. Pat. No. 5,568,924
Date: October 1996
Inventor: Katsuren
Class: 273/292
U.S. Pat. No. 5,871,211
Date: February 1999
Inventor: Was
Class: 273/242
U.S. Pat. No. 5,904,916
Date: May 1999
Inventor: Hirsch
Class: 424/45
U.S. Pat. No. 6,141,797
Date: November 2000
Inventor: Buck
Class: 2/15
U.S. Pat. No. 6,259,889
Date: July 2001
Inventor: LaDue; Christoph Karl
Class: 434/308
U.S. Pat. No. 6,431,874
Date: August 2002
Inventor: Goen
Class: 434/262

### OTHER REFERENCES

Neal J. Cohen, http://www.beckman.uiuc.edu/faculty/cohen.html
Richard Bolstad, http://www.nlp.org/research.htm
http://www.dreamweb.ch/don/nlp.htm
Grinder & Bandler, The Structure of Magic, 1975
Grinder & Bandler, Frogs into Princes, 1978
Grinder, Bandler & DeLozier, Neuro-Linguistic Programming; Volume 1, 1980
Ned Hermann, The Whole Brain Business Book, 1996
Robert Horn, Visual Language: Global Communication For The 21^{st} Century, 1999
D. A. Bernstien, et. al., Psychology (5th Edition), 2000
S. F. Davis & J. J. Palladino, Psychology (3rd Edition), 2000

### BACKGROUND OF THE INVENTION

From the dawn of the printed word, authors and publishers have been striving to improve the readability of their works. Practitioners have tried variations in fonts, colors, pictures, font size, and more. Most or all of these were used to create or improve the ill-defined “visual appeal” of the work. Authors and publishers wanted their reader/viewer to enjoy the visual experience much as one might enjoy viewing a painting. Creating a pleasant viewing experience certainly supports the reading process. In recent decades, advertisers have attempted to improve the art by adding “subliminal” messages, with varying levels of success. Existing art depends greatly on personal preference and cultural bias for its appeal; a layout that is appreciated by one person may be despised by another, while a layout that is popular to one generation may be reviled by another. The existing art is highly subjective.

In the field of memory improvement, there have been a number of advances. Hirsch (U.S. Pat. No. 5,904,916) uses odorants to improve learning capacity by 25%, Davis (U.S. Pat. No. 5,352,181) uses musical composition of varying tempos to enhance learning and self-improvement, Kole (U.S. Pat. No. 4,728,293) claims increased learning when the learner's body is subjected to extra-gravitational forces. This invention extends the practice into the realm of the ocular.

It is well known that brain functions stimulate body movement, for example, when we feel good, we smile. Research has supported the “facial feedback” hypothesis that says forcing a smile, can make one feel better (Bernstein, et al., 2000); Davis and Palladino, 2000).

Although this process is not well understood, the inventors believe that this process of facial feedback is equally applicable to the interaction between the eyes and the brain. It has been shown experimentally that when an individual is accessing certain parts of his or her brain, that the person's eyes will tend to move in predictable patterns (Grinder and Bandler, 1975 & 1978). When accessing past memories, for example, an individual will tend to look to the left. When thinking about a picture, an individual will tend to look up, when considering a physical activity, people tend to look downward, when thinking about the future people tend to look to the right and so on. It is reasonable to assume, therefore, that by forcing eye movement in those particular directions the individual can stimulate particular areas of the brain to more effectively access certain areas of the brain. For example, if I am planning to climb a rock wall, my mind would work most effectively if I first look left and down as I recall other rock walls that I have climbed. Then, I might look upward and to the right to visualize how I might climb this new wall. Appendix A is a review of the classic addressing patterns.

This kind of technique has been proven by experiment to be successful. Bolstad reports how F. Loiselle in 1985 instructed a group of students to study for a spelling test by visualizing the words while looking up and to the left. This group's spelling score increased 25% over that of the control group. The indication here is that forcing the eye toward certain directions for certain tasks will stimulate relevant brain functions to make learning more effective.

In a similar vein, controlling spurious eye movement can improve relaxation and improve memory (U.S. Pat. No. 4,456,347).

Using related technique for the opposite effect, the normal process of memory can be disrupted by forcing rapid eye movement in a variety of directions (U.S. Pat. No. 6,419,629).

Finally, it has been shown that the process of absorbing information can be improved by breaking the information into smaller, more easily readable “chunks” (e.g. using several small and individually relevant boxes of text instead of an entire page of text) (Horn, Visual Language, 1999.

### BRIEF SUMMARY OF THE INVENTION

It is an advantage of the present invention to use the principles of Neurolinguistic Programming (NLP) to define how the information will be displayed (on screen or printed page) to enhance the viewer's mental functions to improve their ability to absorb, understand and recall the information.

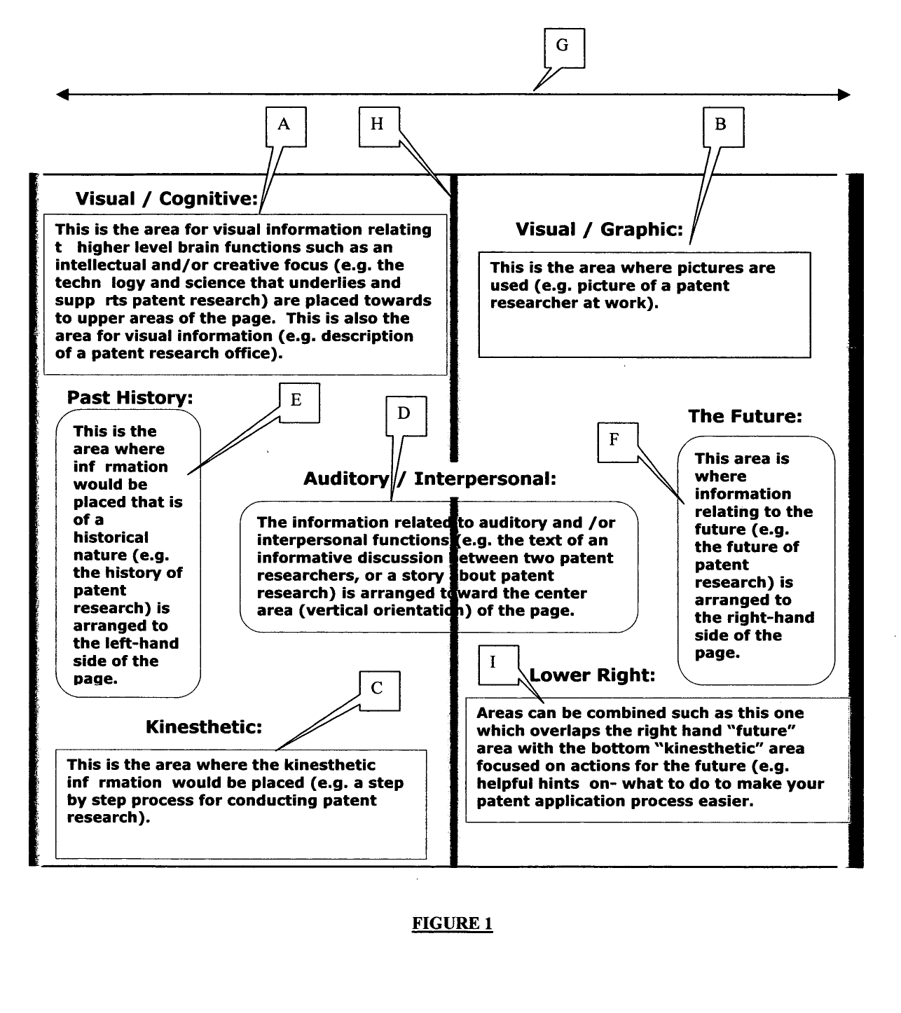

The present invention accomplishes the forgoing objects by arranging specific kinds of information (including cognitive, historical, visionary, interpersonal and others) on a display surface (such as printed page, computer screen, presentation screen and others) in ways that allow and encourage viewers to move their eyes in particular ways (such as up, down, left, right) to view those certain types of information which then causes the viewer to absorb understand and retain the viewed information more easily because the eye movement caused the brain to use those specific areas that relate directly to the viewed information. The present invention is embodied in the following layout (see FIG. 1).

### BRIEF DESCRIPTION OF THE SERIAL VIEWS

Description of FIG. 1:

FIG. 1 is a typical layout of information as it may appear on facing pages of a book, oversized book, projection screen or other form of presentation. The information within the FIGURE both explains and exemplifies the process.

### DETAILED DESCRIPTION

Details of FIG. 1.

A. On the upper area of the display, is presented a block of text which includes information specifically related to higher level brain functions such as that of an intellectual and/or creative focus (e.g. a description of the technology and science that is used for patent research). This is also the area for visually related information (e.g. a description of a patent research office).

B. Pictures and other graphics area also presented in the upper area of the display are (e.g. picture of a patent researcher at work).

C. The bottom area of the display is the area where the kinesthetic information would be placed (e.g. a step by step “how to” process for conducting patent research).

D. The information related to the auditory brain functions including interpersonal functions (e.g. the text of an informative discussion between two patent researchers, or a story about patent research) is arranged in this area toward the center area (vertical orientation) of the page.

E. On the left hand side of the display is the area where information would be placed that is of a historical nature (e.g. the history of patent research).

F. On the right hand side of the display is where information relating to the future (e.g. the future of patent research) is presented.

G. In this embodiment, the size of the display is larger than the normal size to more allow the reader's eyes to more effectively access the relevant areas of his or her brain.

H. In this embodiment the information is presented on a two-page spread to further accentuate the accessing effect.

I. This embodiment shows how variations can be presented, such as this one that combines the “future” area on the right and the “kinesthetic” area on the bottom to create an area focused on actions for the future (e.g. helpful hints on—what to do to make your patent application process easier).

### ALTERNATE EMBODIMENTS

In FIG. 1, we see the preferred embodiment for the majority of the US population. It is understood that other modifications will be evident to those skilled in the art. For example, when left-handed individuals access information, many exhibit eye-movement patterns that are opposite to those of right-handed individuals. An alternative embodiment, therefore might be a reverse-aligned book for left-handed readers. Another embodiment of this invention could be developed by determining the eye-movement/access patterns of an individual and custom-creating a layout to specifically suit that individual's brain accessing patterns. Another embodiment might be on a computer screen or other projection device within a large room for individuals or whole groups.

It should be recognized that, while the invention has been described in relation to a preferred embodiment thereof, those skilled in the art may develop a wide variation of applications without departing from the principles of the invention. Accordingly, the appended claims are to be construed to cover all equivalents falling within the true scope and spirit of the invention. The present example in FIG. 1 and alternative embodiments, therefore, are to be considered in all respects as illustrative and not restrictive, and the invention is not to be limited to the details given herein.

Appendix A

Note, the eye directions listed below are from the point of view of an observer.

From http://www.dreamweb.ch/don/nlp.htm

Eye accessing cues:

When someone's eyes move in a certain direction, you can say if he's thinking is visual, auditory or kinaesthetic.

Vr—Visual remembered: (eyes up to the right): When someone sees images as he has seen them before. He remembers something and visualizes it.
Vc—Visual constructed: (eyes up to the left): Someone sees images of things he has never seen before. He's using his fantasy.
Ar—Auditory remembered: (eyes to the right side): Someone remembers sounds heard before.
Ac—Auditory constructed: (eyes to the left side): Someone constructs sounds he has never heard before.
Ad—Auditory digital: (eyes down to the right): Someone is talking to himself.
K—Kinaesthetic: (Eyes down to the left): Someone feels emotions, sense of touch or muscle movement.

1. A method for arranging visual information (e.g. how to conduct patent research) in a way that causes the viewer to move his or her eyes in certain ways to view certain types of information. This eye movement more effectively stimulates certain areas of the brain thus improve learning and retention.
With each following claim, the viewer's eyes will be directed to a particular direction. That direction will stimulate the area of the brain most related to learning the type of information outlined in the claim.

2. The method according to claim 1, where the visual information as well as information relating to higher level brain functions such as an intellectual and/or creative focus (e.g. the technology and science that underlies and supports patent research) are placed towards to upper areas of the page.

3. The method according to claim 1, where pictures, being visual information (e.g. picture of a patent researcher at work) are arranged toward the upper areas of the page.

4. The method according to claim 1, where the kinesthetic information (e.g. a step by step process for conducting patent research) is arranged toward the lower area of the page.

5. The method according to claim 1, where information related to auditory functions (e.g. the text of an informative discussion between two patent researchers, or a story about patent research) is arranged toward the center area (vertical orientation) of the page.

6. The method according to claim 1, where historical or memory-related information (e.g. the history of patent research or questions that stimulate the reader's own memory) is arranged to the left-hand side of the page.

7. The method according to claim 1, where information relating to the future (e.g. the future of patent research) is arranged to the right-hand side of the page.

8. The method according to claim 1, where the process of learning will be enhanced by the use of certain types of words in certain areas where those types of words relate directly to the area of brain-access. The effects of claim 2 will be enhanced by the use of “sight” words (e.g. “Picture a researcher in his blue cubicle.”). The effects of claim 4 will be enhanced by “physical” words (e.g. The researcher will hand-off the information to his supervisor.”).m 5 will be enhanced by the use of “sound” words (e.g. “Lets hear what an experienced researcher says about data retrieval.”).

9. The method according to claim 1, where the size of the “page” is larger than the average paperback page so as to take up a larger percentage of the viewer's field of vision so as to force the direction of the viewers eyes (although not to a degree that causes distress) to more effectively stimulate the brain.

10. The method according to claim 1, where the “page” may extend across a two-page spread of a book.

11. That using this process in a layout that uses many different forms of information will also have the effect of improving the intelligence of the reader by repeatedly stimulating those many areas of the brain.

12. That stimulating the brain in many different ways will increase the “mental agility” of the brain and so help to maintain the reader's mental vigor into old age.
